(19) United States
(12) Patent Application Publication
(10) Pub. No.: US 2005/0039756 A1
(43) Pub. Date: Feb. 24, 2005

(54) Methods of making laryngeal masks

(76) Inventor: Daniel J. Cook, Richmond Heights, MO (US)

Correspondence Address: Ahaji Amos, 3810 Rita Elliott Court, Missouri City, TX, 77459, US

(21) Appl. No.: 10/691,348

(22) Filed: Oct. 22, 2003

Related U.S. Application Data
(63) Continuation-in-part of application No. 09/829,157, filed on Apr. 9, 2001, now Pat. No. 6,705,321.
Application No. 09/829,157 is a continuation-in-part of application No. 09/179,928, filed on Oct. 27, 1998, now Pat. No. 6,422,239.
Application No. 09/179,928 is a division of application No. 08/843,631, filed on Apr. 10, 1997, now Pat. No. 5,937,860.

(51) Int. Cl. A62B 7/00

(52) U.S. Cl. 128/207.15

(57) ABSTRACT

A method of making a laryngeal airway of the type that includes a respiratory tube and an inflatable positioning shield having a base and an inflatable, hollow peripheral portion is described herein. The method includes introducing at least one molding material onto internal walls of a mold, wherein the mold has a cavity defined by internal walls that conform to the external wall of the laryngeal airway, and wherein only a sufficient amount of the molding material is introduced onto the internal walls of the mold that is necessary to create external walls of the laryngeal airway having a desired thickness and allowing the molding material to cure about the internal walls, thereby forming laryngeal mask.

### CROSS-REFERENCE TO RELATED APPLICATIONS

This is a continuation-in-part of U.S. patent application Ser. No. 09/829,157, filed Apr. 9, 2001, which is a continuation-in-part of U.S. patent application Ser. No. 09/179,928, filed on Oct. 27, 1998, and issued as U.S. Pat. No. 6,422,239 on Jul. 23, 2002, which is a divisional of U.S. Pat. No. 5,937,860, which issued on Aug. 17, 1999.

### STATEMENT REGARDING FEDERALLY SPONSORED RESEARCH OR DEVELOPMENT

Not applicable.

### BACKGROUND OF THE INVENTION

This invention relates to methods of making artificial airway devices, and more specifically to methods of making artificial airway devices that are designed to facilitate lung ventilation and the insertion of endotracheal tubes or related medical instruments into the laryngeal opening of an unconscious patient.

In general, laryngeal masks allowing for both rapid lung ventilation and the insertion of medial instruments and tubes into the laryngeal openings of patients have been described in patents such as U.S. Pat. No. 5,937,860 to Cook. Consisting of two essential parts, a breathing tube and an inflatable positioning shield or mask, these instruments or devices are inserted blindly into a patient's throat, and when properly positioned, terminate at the laryngeal opening. Generally, a seal is then formed around the circumference of the laryngeal opening by the inflation of the ring-like peripheral portion of the mask. Inflation of the peripheral portion exerts pressure against both the front and rear portions of the oropharynx, securing the device in place such that the laryngeal opening is positioned within a cavity in the mask face. Extending from a point external to the oral cavity, the flexible breathing tube terminates within the cavity, aligned axially with the laryngeal opening. The positioning of the flexible breathing tube allows the passage of endotracheal tubes or related medical instruments into the laryngeal opening, in addition to allowing for lung ventilation.

Laryngeal airway devices of this type are typically manufactured by one of two methods. One method involves forming the upper and lower portions of the inflatable peripheral portion of the mask separately using various molding techniques. The two portions are then connected using heat, pressure, adhesives, or combinations thereof Laryngeal airway devices of this type have also been manufactured using blow-molding techniques, which involve forming an essentially flat balloon, and later bringing the central portion of the flat balloon together using heat or pressure to form the hollow, peripheral portion of the mask. The flattened central portion forms the base, while the peripheral portion of the balloon remains hollow.

While these methods have been successfully used to manufacture laryngeal airway devices, there are several disadvantages to using such methods. First, several process steps are necessary to manufacture a market-ready product, which results in increased manufacturing costs. Second, where the components of the mask are manufactured separately, and later joined, seams are formed, which provide areas of compromised stability therein. Third, blow molding produces walls of universal thickness, which make it impossible to produce airway walls of sufficient thickness to prevent collapse of the airway, and walls of sufficient thinness to produce a hollow inflatable positioning shield.

Therefore, a method for producing laryngeal airway devices of the type that include a respiratory tube and an inflatable positional shield having a central support structure and an inflatable peripheral portion are needed that avoids these problems.

### SUMMARY OF THE INVENTION

Briefly, in a first aspect of the invention, a method of making a laryngeal airway of the type that includes a respiratory tube and an inflatable positioning shield, the shield having a base and an inflatable, hollow, peripheral portion is provided that comprises introducing at least one molding material onto internal walls of a mold, wherein the mold has a cavity defined by internal walls, wherein the internal walls conform to external walls of the laryngeal airway, and wherein a minimum amount of the molding material is introduced onto the internal walls of the mold that is necessary to create external walls of the laryngeal airway having a desired thickness, and allowing the molding material to cure about the internal walls of the mold, thereby forming the laryngeal airway;

In a second aspect of the invention, a method of making a laryngeal airway of the type described above is provided that comprises introducing liquid polyvinyl chloride onto internal walls of a mold, wherein the mold has a cavity defined by internal walls, wherein the internal walls conform to external walls of the laryngeal airway, and wherein a minimum amount of polyvinyl chloride is introduced onto the internal walls of the mold that is necessary to create a laryngeal airway having a desired wall thickness, and allowing the molding material to cure about the internal walls of the mold, thereby forming the laryngeal airway, wherein the laryngeal airway comprises a base, which comprises a respiratory tube, and the base is inserted into the mold prior to introduction of the polyvinyl chloride into therein;

In a third aspect of the invention, a method of making a laryngeal airway of the type described above is provided that comprises introducing polyvinyl chloride onto internal walls of a mold, wherein the mold has a cavity defined by the internal walls, wherein the internal walls conform to external walls of the inflatable positioning shield and the respiratory tube, the respiratory tube having a distal end that passes through and is secured to the rear portion of the positioning shield and a proximal end for attachment to medical devices, wherein a minimum amount of polyvinyl chloride is introduced onto the internal walls of the mold that is necessary to create an inflatable positioning shield having external walls about 0.5 millimeters to about 1.5 millimeters thick, and allowing the molding material to cure about the internal walls of the mold, wherein the laryngeal airway comprises a base and the base is inserted into the mold prior to introduction of the polyvinyl chloride into the mold, and wherein the base comprises a respiratory tube, thereby forming the inflatable positioning shield.

In a fourth aspect of the invention, a method of making a laryngeal airway is provided that comprises placing a base into a mold, the mold having a cavity defined by internal walls that are adapted to produce the external walls of a laryngeal airway that comprises an inflatable positioning shield and a respiratory tube, the inflatable positioning shield having an inflatable, hollow peripheral portion in fluid communication with the base, the base having a recessed front portion that is sufficiently pliable to cup a patient's trachea after inflation of the inflatable positioning shield, a shield recess formed after inflation of the peripheral portion, and a rear portion formed between the base and the peripheral portion after inflation of the peripheral portion, the flexible respiratory tube having a proximal end lumen, a curved tubular body of sufficient size to permit passage of endo-tracheal tubes or related medical instruments therethrough, and a distal end passing through and secured to the rear portion of the positioning shield, the distal end terminating at a distal lumen, the distal lumen passing through and secured to the rear portion of the positioning shield, introducing at least one molding material onto the internal walls of the mold, and allowing the mold to cure about the internal walls of the mold to produce the laryngeal airway, wherein a minimum amount of the molding material is introduced onto the internal walls of the mold that is necessary to create a laryngeal airway having a desired wall thickness; and

In a fifth aspect of the invention, a method of making a laryngeal airway of the type that includes a respiratory tube and an inflatable positioning shield is provided that comprises introducing at least one molding material onto internal walls of a mold, the internal walls conforming to the external walls of the inflatable positioning shield, allowing the molding material to cure about the internal walls of the mold, thereby producing the inflatable positioning shield, and connecting the inflatable positioning shield to the respiratory tube, wherein a minimum amount of the molding material is introduced onto the internal walls of the molding material that is necessary to create an inflatable positioning shield having a desired wall thickness.

### BRIEF DESCRIPTION OF THE DRAWINGS

In the drawings, FIG. 1 is a top view of the laryngeal mask illustrating the endotracheal tube and the inflatable positioning shield;

FIG. 2 is a partial plan view of the mold of the invention; and

FIG. 3 is a partial plan view of the mold invention.

### DESCRIPTION OF THE PREFERRED EMBODIMENTS

New and useful methods of making a laryngeal airway of the type that includes a respiratory tube and an inflatable positioning shield having a base and an inflatable, hollow, peripheral portion, have been discovered. Referring to FIG. 1, one embodiment of the invention is shown in reference to an inflatable positioning shield 22 fitted to the distal end of a respiratory tube 26. The laryngeal mask 10 comprises a respiratory tube 26, which provides ventilation, a direct pathway for medical devices and instruments into the laryngeal inlet and also may provide alternate airways to limit blockage of breathing tubes during patient ventilation, and an inflatable positioning shield 22, which will be understood to be relatively shaped for manipulated entry into a position within a patient's pharyngeal cavity. The proximal end 28 of respiratory tube 26 is accessible for ventilation, or outside the patient's mouth. Respiratory tube 26 may be of sufficient size to permit proximal end 28 to be accessible for ventilation outside of the patient's mouth. However, respiratory tube 26 may not be of sufficient size to permit proximal end 28 to be accessible to ventilation outside of the mouth. In this embodiment, at least one additional respiratory tube may be connected to proximal end 28 of respiratory tube 26 to extend the length of respiratory tube 26.

Respiratory tube 26 comprises a proximal end lumen, a tubular body of sufficient size to permit passage of endotracheal tubes or related medical instruments therethrough, and a distal end 24 passing through and secured to positioning shield 22. Distal end 24 of respiratory tube 26 terminates at distal lumen 32, which passes through and is secured to positioning shield 22 such that tubes and instruments passing through respiratory tube 26 will be directed into the laryngeal opening. Inflatable positioning shield 22 comprises an inflatable, hollow, peripheral portion 40, which encircles a base 42. A rear portion 45 and a shield recess 36 are formed between base 42 and peripheral portion 40 upon inflation of peripheral portion 40.

It is contemplated that airway devices of the general type described herein may be produced using the methods of the invention. However, as one skilled in the art can appreciate, the methods described herein may be employed to produce various embodiments of laryngeal airway device 10. The internal walls of the mold must conform to the exterior walls of the specific airway device desired. For example, and with reference to FIG. 1, the methods described herein may be employed to produce embodiment of laryngeal airway 10 wherein base 42 comprises ventilation lumens 34 disposed about distal end 24 of respiratory tube 26. Distal lumen 32 may be of various shapes including, but not limited to a keyhole shape, oval shape, or circular shape. Peripheral portion 40 may comprise a recessed front portion 43, as shown in FIG. 1, and described in U.S. Pat. No. 5,937,860 to Cook. Recessed front portion 43 is adapted to cup a patient's trachea after inflation of peripheral portion 40. Also, respiratory tube 26 may have various cross-sectional shapes including, but not limited to circular and oval shapes. Further, the mask itself may be of various shapes, including but not limited to oval, or wedge shaped. Moreover, respiratory tube 26 may terminate at the proximal end of the peripheral portion 40. As such, respiratory tube 26 may not pass through positioning shield 22. In specific embodiments, respiratory tube 26 is connected to inflatable positioning shield 22.

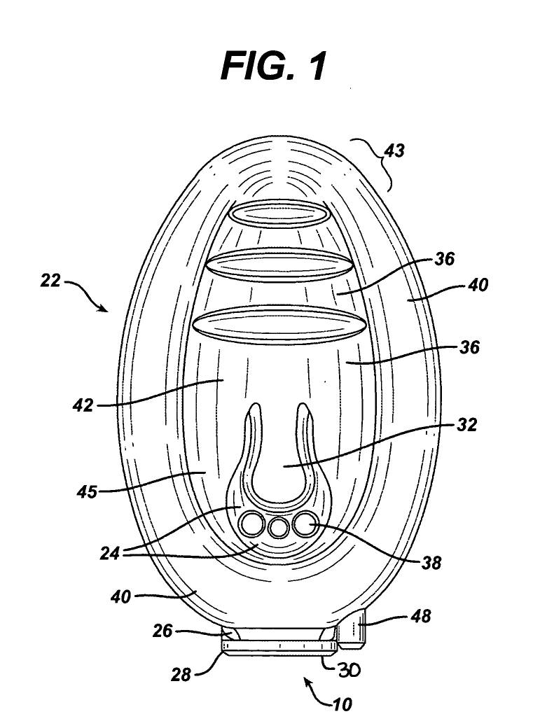

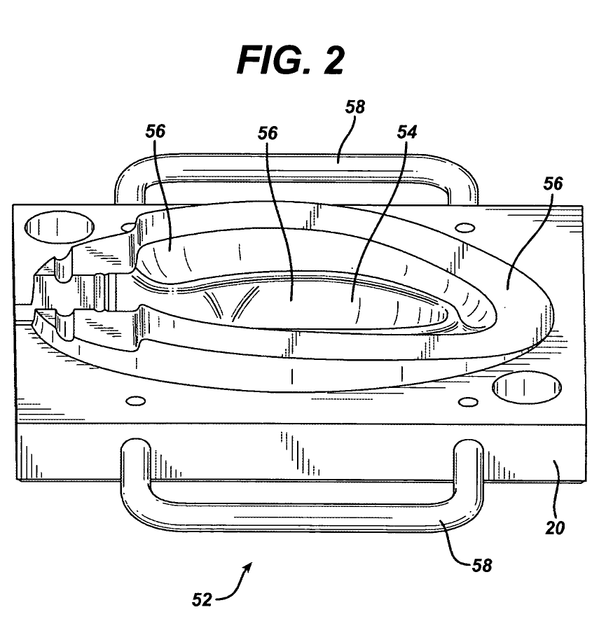

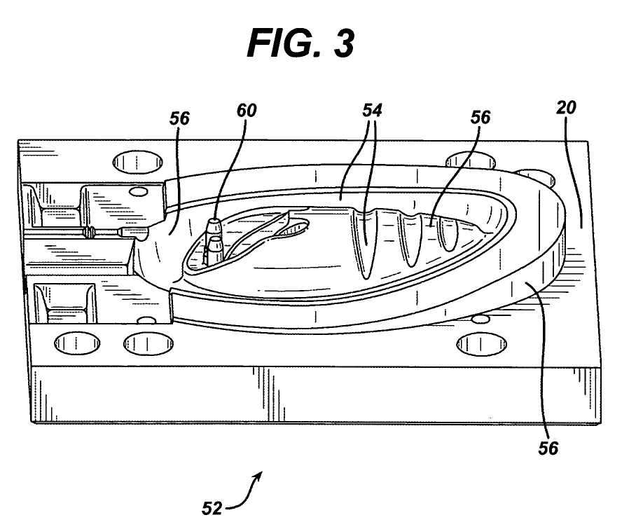

In accordance with the invention and with reference to FIGS. 2 and 3, one embodiment of the method comprises introducing at least one molding material onto internal walls of a mold 52, wherein mold 52 has a cavity 54 defined by internal walls 56, wherein internal walls 56 conform to the external walls of laryngeal airway 10, and allowing the molding material to cure about internal walls 56 of mold 52, thereby forming the externals walls of laryngeal airway 10. Mold 52 is designed to produce a laryngeal airway in a market-ready configuration. The airway produced need not be inverted prior to use as with prior art molding processes. The molded product is simply stripped out after the curing process is complete. This reduces the amount of time and financial resources necessary for manufacturing the airway. The phrase “laryngeal airway” refers to the device generally described and shown at 10 in FIG. 1. However, as used herein, the phrase applies more broadly to the positioning shield portion of the laryngeal airway device that includes an inflatable peripheral portion and a base. Accordingly, as used herein, a laryngeal airway may, or may not comprise a respiratory tube. It should be noted that it is within the scope of the invention for the sequence of the steps of the invention to be altered.

The molding material is introduced onto internal walls 56 by any known means of accomplishing such. The mode of introduction is not critical to the invention. A liquid form of the molding material may be poured into mold 52 in one embodiment. A paste form of the molding material may be introduced into mold 52 by pouring, pressing, or placing the molding material directly onto the internal walls of the mold in another embodiment. The molding material may also be dripped or sprayed into mold 52 using high or low pressure injection techniques in a further embodiment. To facilitate distribution of the molding material into the cavity of mold 52 and onto internal walls 56, and in one embodiment of the invention, mold 52 may be manipulated after introduction of the molding material therein to facilitate equal distribution of the molding material. Mold 52 may be vibrated, shaken, or rotated to facilitate distribution. It should be understood that manipulation of mold 52 is not critical to the practice of the invention described herein.

In one embodiment of the invention, mold 52 is warmed before or after the molding material is introduced thereto. As used herein, the term “warm” means to elevate the temperature to a temperature that is higher than room temperature. Generally, liquid molding materials are warmed prior to introduction into mold 52. The molding materials are generally in a liquid state only when warmed and solidify when cooled to room temperature. The temperature necessary to liquefy the molding materials of the invention varies depending on the specific composition of the molding material. Some molding materials require a very high temperature to achieve a liquid state, while others require a lower temperature to achieve a liquid state. It should be understood, however, that it is not critical that the molding materials be liquid to practice the invention. It should also be noted that some molding materials form a paste when warmed. The utilization of these molding materials is also within the scope of the invention.

The molding material is allowed to cure about internal walls 56 to form the external walls of laryngeal airway 10. The curing process generally only takes a few minutes to complete, but may take more or less time depending upon the specific molding material employed, the environmental conditions that exists at the time of curing, and the desired thickness of the walls of the laryngeal airway formed. To decrease the curing time, mold 52 may be cooled either before the molding material is introduced therein, or after introduction of the molding material. Mold 52 is cooled by decreasing its temperature to a temperature that is at or below room temperature.

The methods of the invention are achieved utilizing a mold that is designed to produce hollow, peripheral portion 40 of positioning shield 22. One embodiment of a mold suitable for use in the invention is illustrated in FIGS. 2 and 3 at 52. Mold 52 must have a cavity 54 defined by internal walls 56, which conform to the external surface of the desired laryngeal airway. The methods of the invention allow peripheral portion 40 to be produced without the use of cores or other devices to create a hollow peripheral portion, and a respiratory tube. In the embodiment illustrated in FIGS. 2 and 3, mold 52 comprises at least one plate of 20, which forms the internal walls 56 and cavity 54. Generally, one plate 20 conforms to the upper portion of the airway and a second plate conforms to the lower portion of the airway. These plates are connected, using any known means for connecting such, in a manner that allows the peripheral portions of internal walls 56 to communicate and conform to the shape of the exterior walls of the laryngeal airways being produced. Plates 20 may be connected using pins, hinges, or other connection devices. They may also be held together by hand or by the use of gravity. A handle 58 may be employed to facilitate use of the mold. In other embodiments, the mold may be of unitary construction and may not comprise plates. Any mold may be used in accordance with the invention that conforms to the exterior surface of the desired laryngeal mask.

The methods described herein may be employed to produce various embodiments of the general laryngeal airway 10. The internal walls of the mold must conform to the exterior walls of the specific airway device desired. For example, and with reference to FIG. 1, mold 52 may be designed in accordance with the invention to produce an embodiment of laryngeal airway 10 wherein base 42 comprises ventilation lumens 38 disposed about distal end 24 of respiratory tube 26. Distal lumens 32 may be of various shapes including, but not limited to a keyhole shape, oval shape, or circular shape. Peripheral portion 40 may comprise recessed front portion 43, as shown in FIGS. 1 and 3, and described in U.S. Pat. No. 5,937,860 to Cook. Recessed front portion 43 is adapted to cup a patient's trachea after inflation of peripheral portion 40. Also, respiratory tube 26 may have various cross-sectional shapes including, but not limited to circular and oval shapes. Further, positioning shield 22 itself may be of various shapes, including but not limited to oval, and wedge shapes. Molds that are adapted to produce these, and other embodiments of laryngeal airway 10 are within the scope of the invention described herein.

In one specific embodiment of the invention, internal walls 56 of mold 52 are designed to produce laryngeal mask 10, depicted in FIG. 1. Inflatable positioning shield 22 has an inflatable, hollow peripheral portion 40 in fluid communication with base 42. Base 42 has a recessed front portion 43 that is sufficiently pliable to cup a patient's trachea after inflation of inflatable positioning shield 22. Shield recess 36 is formed after inflation of peripheral portion 40, and rear portion 45 is formed between base 42 and peripheral portion 40 upon inflation of peripheral portion 40. Flexible respiratory tube 26 has a proximal end lumen, a curved tubular body of sufficient size to permit passage of endo-tracheal tubes or related medical instruments therethrough, and distal end 24 passing through and secured to rear portion 45. Distal end 24 terminates at distal lumen 32. Distal lumen 32 passes through and is secured to rear portion 45. Peripheral portion 40 also comprises a means 48 for allowing inflation of peripheral portion 40 that is generally located in a proximal area of peripheral portion 40, near distal end 24. However, the means for allowing inflation of peripheral portion 40 may be in any convenient location, provided that inflation of peripheral portion 40 after insertion into a patient's airway is not hindered. The means for allowing inflation is generally a small aperture, which may be circular, oval or slot-shaped.

In opposite to injection molding and other molding techniques, the mold's cavity is not filled with the molding material. Only a minimum amount of the molding material is introduced into the mold that is necessary to create walls having a desired thickness. In one embodiment of the invention, the excess molding material is discarded from mold 52 before the molding material is allowed to cure within mold 52. Molding material is considered excess material when it exceeds the amount necessary to create walls having a desired thickness. As one skilled in the art could appreciate, it is also contemplated that there may be no excess molding material to discard. The specific amount of material necessary to create the desired wall thickness may be introduced into mold 52, eliminating the need for removal of any molding material. This amount varies and is depended upon various factors, including the specific environmental conditions present at the time of introduction, the specific composition of the molding material employed, as well as the shape, size and configuration of the mold itself It should also be understood that the thickness of the walls is not critical to achieve the objects of the invention. The walls formed, however, must be thick enough to withstand the pressure and wear associated with patient intubation and thin enough such that patient intubation is not inhibited or complicated. If the walls are too thin there is a risk of tearing during intubation. However, the walls must be thin enough such that a sufficient amount of airspace is present within peripheral portion 40 to allow proper inflation of peripheral portion 40. When inflated properly, peripheral portion 40 exerts pressure against the structures of the oropharynx. One skilled in the art could readily determine the proper amount of molding material that should be introduced into mold 52 without undue experimentation. Generally, and in one embodiment of the invention, the molding material is introduced in an amount that will create external walls that are about 0.5 to about 1.5 millimeters thick. If it is found that the walls are too thin after the molding material has cured, an additional amount of the molding material may be introduced to internal walls 56 of mold 52 directly on top of the cured molding material. This step may be repeated until the desired thickness is achieved.

As one skilled in the art would appreciate, mold 52 may also be designed to produce any component of laryngeal airway 10. As such, the need for connecting other portions of the laryngeal airway 10, such as respiratory tube 26 and base 42 are avoided. Mold 52 simply must conform to the outer surface of laryngeal airway 10, including those components to be molded. For example, and in one embodiment, mold 52 is designed to produce base 42, peripheral portion 40, and respiratory tube 26. In that case, internal walls 56 conform to the external surface of peripheral portion 40, base 42 and respiratory tube 26. In another embodiment of the invention, mold 52 conforms to the external walls of hollow peripheral portion 40 only. Base 42 may be manufactured separately and connected to peripheral portion 40 before, or after the molding material is introduced into mold 52. In embodiments where base 42 is connected to peripheral portion 40 before the molding material is allowed to cure, base 42 is generally inserted or placed inside mold 52 before the molding material is introduced therein. In embodiments where base 42 and peripheral portion 40 are connected after the molding material is allowed to cure, the two components are connected by known connection methods, including but not limited to the use of heat, pressure, or adhesives. The specific adhesive used is not critical and is largely dependant upon the specific composition of the molding materials employed. Suitable adhesives can be readily determined without undue experimentation and are widely commercially available.

By way of further example, and with reference to FIG. 3, where small diameter lumens 38 in distal end 24 of respiratory tube 26 are desired, cores or extensions 60 of mold 52 may be employed. Extensions 60 would extend from internal walls 56 and create voids or thinned walls in distal end 24 of respiratory tube 26. The voids could also be created by many other methods, including avoiding the introduction of the molding material onto extended cores 60. This could be accomplished by deliberately manipulating mold 52 during introduction of the molding material therein. The molding material could also be introduced onto extensions 60 to produce protruding members, and the protruding members could be removed after the molding material has cured.

Hollow, peripheral portion 40 is connected to base 42 to form laryngeal airway 10. Base 42 may be connected to peripheral portion 40 prior to, or after the introduction of the molding material therein. Base 42 may be connected to peripheral portion 40 by any known connection methods, including but not limited to the use of heat, pressure, adhesives, or combinations thereof The specific methods employed are largely dependent upon the specific composition of the laryngeal airway produced. In one embodiment, base 42 is connected to peripheral portion 40 by the application of heat. The heat is used to partially melt peripheral portion 40 and base 42 at the point at which the outer peripheral portion of base 42 and the inner periphery of peripheral portion 40 connect to form laryngeal airway 10. The connection point is then allowed to cool, and base 42 and peripheral portion 40 are connected. Pressure may also be used to connect base 42 and peripheral portion 40. When pressure is employed as a means for connection, force is applied to the two components, which results in fusion. Base 42 and peripheral portion 40 may also be connected using adhesives. The specific type of adhesive employed would be apparent to those skilled in the art, and is largely dependent on the specific composition of the laryngeal airway desired. Another connection method involves introducing base 42 into mold 52 prior to introduction of the molding material therein. As the molding material cures about base 42, peripheral portion 40 and base 42 are fluidly connected.

With reference to FIG. 1, and in one embodiment of the invention, base 42 also comprises respiratory tube 26. Respiratory tube 26 may pass through and be secured to the proximal portion of positioning shield 22. Respiratory tube 26 may also be connected the proximal portion of positioning shield 22, but not through positioning shield 22. Respiratory tube 26 may be connected to inflatable positioning shield 22 immediately after inflatable positioning shield 22 is formed, or after some time. In this embodiment, base 42 and respiratory tube 26 comprise a central unitary structure. The central unitary structure comprises a respiratory tube and a base, generally. This central unitary structure may be inserted into the mold prior to the introduction of the molding material therein. The central unitary structure is generally comprised of the same material as peripheral portion 40. However, it is envisioned that it may comprise different materials of manufacture. The materials of manufacture need not be the same, however, they must be able to be connected by known connection methods. In accordance with the invention, the central structure is placed into mold 52 such that the outer periphery of the central structure will be aligned with the inner periphery of peripheral portion 40 after curing. When the molding material is introduced and allowed to cure about internal walls 56, peripheral portion 40 becomes fluidly connected with the central unitary structure. Alternatively, peripheral portion 40 is allowed to cure about internal walls 56, and is connected to the central unitary structure after peripheral portion 40 is formed using any known connection means.

In one embodiment of the invention, a secondary base is introduced onto base 42. In some cases, base 42 may be too thin to withstand the trauma associated with use. In that case, a secondary base may be introduced onto base 42 after laryngeal airway 10 is formed to add stability to base 42.

The molding material employed may generally be any medically inert flexible plastic material, rubber material, or any other material, including but not limited to polyvinyl chloride, silicone, polyurethane, EVA, TPE, polyether block amide, another flexible resin, combinations or mixtures thereof and the like. As such, one skilled in the art would appreciate that the molding material may be in various forms, including but not limited to paste and liquid forms. In specific embodiments of the invention, the molding material is polyvinyl chloride (“PVC”). PVC is liquid form when warmed, which facilitates easy introduction into molds, is medically inert, and able to cure at room temperature. It is also inexpensive, and therefore ideal for producing disposable laryngeal airways 10, which are commonly used by medical personnel.

In view of the above, it will be seen that all the objects and features of the present invention are achieved, and other advantageous results obtained. The description of the invention contained herein is illustrated only, and is not intended in a limiting sense.

1. A method of making a laryngeal airway of the type that includes an inflatable positioning shield, the shield having a base and an inflatable, hollow, peripheral portion, the method comprising:
introducing at least one molding material onto internal walls of a mold;
wherein the mold has a cavity defined by the internal walls;
wherein the internal walls conform to external walls of the laryngeal airway; and
wherein a minimum amount of the molding material is introduced onto the internal walls of the mold that is necessary to create external walls of the laryngeal airway having a desired thickness; and
allowing the molding material to cure about the internal walls of the mold, thereby forming the laryngeal airway.

2. The method of claim 1 wherein the molding material is a paste.

3. The method of claim 1 further comprising removing the laryngeal airway from the mold.

4. The method of claim 1 wherein the base is inserted into the mold prior to introduction of the molding material into the mold.

5. The method of claim 4 wherein the base comprises a respiratory tube.

6. The method of claim 1 further comprising discarding excess molding material from the mold.

7. The method of claim 1 wherein the molding material is a liquid.

8. The method of claim 1 wherein the mold conforms to the external walls of the hollow peripheral portion of the inflatable positioning shield.

9. The method of claim 8 further comprising connecting the inflatable, hollow peripheral portion to the base.

10. The method of claim 7 wherein the inflatable, hollow peripheral portion is connected to the base before the molding material is allowed to cure.

11. The method of claim 7 wherein the inflatable, hollow peripheral portion is connected to the base after the molding material is allowed to cure.

12. The method of claim 7 wherein the connection is accomplished using heat, pressure, or an adhesive.

13. The method of claim 1 further comprising manipulating the mold to distribute the molding material about the internal walls of the mold.

14. The method of claim 1 wherein the molding material is polyvinylchloride.

15. The method of claim 1 wherein the molding material is a plastic.

16. The method of claim 1 wherein the internal walls of the mold conform to the external walls of a laryngeal airway that comprises an inflatable positioning shield and a respiratory tube, the inflatable positioning shield having an inflatable, hollow peripheral portion in fluid communication with the base, the base having a recessed front portion that is sufficiently pliable to cup a patient's trachea after inflation of the inflatable positioning shield, a shield recess formed after inflation of the peripheral portion, and a rear portion formed between the base and the peripheral portion after inflation of the peripheral portion, the flexible respiratory tube having a proximal end lumen, a curved tubular body of sufficient size to permit passage of endo-tracheal tubes or related medical instruments, and a distal end passing through and secured to the rear portion of the positioning shield, the distal end terminating at a distal lumen, the distal lumen passing through and secured to the rear portion of the positioning shield.

17. The method of claim 1 wherein the mold has internal walls that conform to the external walls of the inflatable positioning shield.

18. The method of claim 17 further comprising connecting the inflatable positioning shield to the respiratory tube by ultra-sonic bonding.

19. The method of claim 18 wherein the connection is accomplished using heat, pressure or an adhesive.

20. The method of claim 1 wherein the molding material is at least one selected from the group consisting of polyvinylchloride, polyurethane, EVA, TPE, polyether block amide, a flexible plastic, a rubber material, silicone, combinations or mixtures thereof and the like.

21. The method of claim 1 wherein the step of introducing at least one molding material onto the internal walls of the mold is repeated after the molding material is allowed to cure.

22. The method of claim 1 further comprising warming the mold prior to introducing the molding material therein.

23. The method of claim 1 further comprising cooling the mold prior to introducing the molding material therein.

24. The method of claim 1 further comprising cooling the mold after the molding material is introduced therein.

25. The method of claim 1 further comprising warming the mold after the molding material is introduced therein.

26. The method of claim 1 wherein the molding material is introduced into the mold in an amount that is sufficient to form a laryngeal airway that has external walls about 0.5 to about 1.5 millimeters thick.

27. The method of claim 1 wherein the external walls of the laryngeal airway formed is about 0.5 to about 1.5 millimeters thick.

28. The method of claim 1 wherein the molding material is silicone.

29. A method of making a laryngeal airway of the type that includes an inflatable positioning shield, the shield having a base and a hollow peripheral portion, the method comprising:
introducing polyvinyl chloride onto internal walls of a mold;
wherein the mold has a cavity defined by the internal walls;
wherein the internal walls conform to external walls of the laryngeal airway; and
wherein a minimum amount of polyvinyl chloride is introduced onto the internal walls of the mold that is necessary to create a laryngeal airway having a desired wall thickness; and
allowing the molding material to cure about the internal walls of the mold, thereby forming the laryngeal airway;
wherein the laryngeal airway comprises a base and the base is inserted into the mold prior to introduction of the polyvinyl chloride into the mold and;
wherein the base comprises of a respiratory tube.

30. A method of making a laryngeal airway of the type that includes an inflatable positioning shield, the shield having a base and an inflatable, hollow, peripheral portion, the method comprising:
introducing polyvinyl chloride onto internal walls of a mold;
wherein the mold has a cavity defined by the internal walls;
wherein the internal walls conform to external walls of the inflatable positioning shield and the respiratory tube, the respiratory tube having a proximal end for attachment to medical devices and a distal end passing through and secured to the rear portion of the positioning shield,
wherein a minimum amount of polyvinyl chloride is introduced onto the internal walls of the mold that is necessary to create an inflatable positioning shield having external walls about 0.5 millimeters to about 1.5 millimeters thick; and
allowing the molding material to cure about the internal walls of the mold, thereby forming the laryngeal airway;
wherein the laryngeal airway comprises a base and the base is inserted into the mold prior to introduction of the polyvinyl chloride into the mold; and
wherein the base comprises a respiratory tube.

31. A method of making a laryngeal airway comprising:
placing a base into a mold, the mold having a cavity defined by internal walls, wherein the internal walls are adapted to produce the external walls of a laryngeal airway that includes an inflatable positioning shield and a respiratory tube, the inflatable positioning shield having an inflatable, hollow peripheral portion in fluid communication with the base, the base having a recessed front portion that is sufficiently pliable to cup a patient's trachea after inflation of the inflatable positioning shield, a shield recess formed after inflation of the peripheral portion, and a rear portion formed between the base and the peripheral portion after inflation of the peripheral portion, the flexible respiratory tube having a proximal end lumen, a curved tubular body of sufficient size to permit passage of endo-tracheal tubes or related medical instruments therethrough, and a distal end passing through and secured to the rear portion of the positioning shield, the distal end terminating at a distal lumen, the distal lumen passing through and secured to the rear portion of the positioning shield;
introducing at least one molding material onto the internal walls of the mold; and
allowing the molding material to cure about the internal walls of the mold to produce the laryngeal airway;
wherein a minimum amount of the molding material is introduced onto the internal walls of the mold that is necessary to create a laryngeal airway having a desired wall thickness.

32. A method of making a laryngeal airway of the type that includes an inflatable positioning shield, the method comprising:
introducing at least one molding material onto internal walls of a mold, the internal walls conforming to the external walls of the inflatable positioning shield;
allowing the molding material to cure about the internal walls of the mold, thereby producing the inflatable positioning shield; and
connecting the inflatable positioning shield to the respiratory tube,
wherein a minimum amount of the molding material is introduced onto the internal walls of the molding material that is necessary to create external walls of the inflatable positioning shield.

33. The method of claim 32 wherein the inflatable positioning shield comprises a base and the base is inserted into the mold prior to introduction of the molding material.

34. The method of claim 32 further comprising discarding excess molding material from the mold.

35. The method of claim 32 wherein the molding material is liquid.

36. The method of claim 32 wherein the molding material is a paste.

37. The method of claim 32 further comprising manipulating the mold to distribute the molding material about the internal walls.

38. The method of claim 32 wherein the molding material is polyvinylchloride.

39. The method of claim 32 wherein the flexible respiratory tube has a proximal end lumen, a curved tubular body of sufficient size to permit passage of endo-tracheal tubes or related medical instruments, and a distal end passing through and secured to the rear portion of the positioning shield, the distal end terminating at a distal lumen, the distal lumen passing through and secured to the rear portion of the positioning shield.

40. The method of claim 32 wherein the mold comprises internal walls that are adapted to produce an inflatable positioning shield, the inflatable positioning shield having an inflatable, hollow peripheral portion in fluid communication with the base, the base having a recessed front portion that is sufficiently pliable to cup a patient's trachea after inflation of the inflatable positioning shield, a shield recess formed after inflation of the peripheral portion, and a rear portion formed between the base and the peripheral portion after inflation of the peripheral portion.
